(19) United States
(12) Patent Application Publication
(10) Pub. No.: US 2019/0073115 A1
(43) Pub. Date: Mar. 7, 2019

(54) CUSTOM DIGITAL OVERLAY KIT FOR AUGMENTING A DIGITAL IMAGE

(71) Applicant: CRAYOLA, LLC, Easton, PA (US)

(72) Inventors: Joseph Thomas Moll, Bethlehem, PA (US); Brian Edward Nemeckay, Belvidere, NJ (US)

(21) Appl. No.: 16/122,195

(22) Filed: Sep. 5, 2018

Related U.S. Application Data
(60) Provisional application No. 62/554,192, filed on Sep. 5, 2017.

(51) Int. Cl. G06F 3/0484; G06K 9/00; G06F 3/0482

(52) U.S. Cl. CPC G06F 3/04842; G06F 3/0482; G06K 9/00671

(57) ABSTRACT

Systems and methods for enhancing a user-selectable image using a template overlay kit are described. The template overlay kit comprises a template portfolio including a first template page having a design template configured to receive a user marking. The template overlay kit further comprises an overlay kit application that, when executed by a computing device, receives a captured image of the design template and the user marking, and generates a custom digital overlay in a display of the computing device. A custom digital overlay is generated from a digital overlay template that incorporates the user marking received by the design template. The overlay kit application then augments one or more facial features detected in the user-selectable image using the custom digital overlay incorporating the user marking.

### CROSS-REFERENCE TO RELATED APPLICATIONS

This application is a non-provisional application that claims priority to U.S. Provisional Application No. 62/554,192, entitled “CUSTOM DIGITAL OVERLAY KIT FOR AUGMENTING A DIGITAL IMAGE,” filed on Sep. 5, 2017, which is incorporated by reference in its entirety.

### SUMMARY

Embodiments of the disclosure are defined by the claims below, not this summary. A high-level overview of various aspects of the disclosure are provided here for that reason, to provide an overview of the disclosure, and to introduce a selection of concepts that are further described in the Detailed Description section below. This summary is not intended to identify key features or essential features of the claimed subject matter, nor is it intended to be used as an aid in isolation to determine the scope of the claimed subject matter.

In brief and at a high level, this disclosure describes, among other things, systems and methods for augmenting a digital image using a template overlay kit. Exemplary embodiments of the template overlay kit include a template portfolio comprising a template page having a design template, wherein the design template is configured to receive a user marking on the surface of the template page. In embodiments, an overlay kit application for execution by a computing device, such as a personal computer or handheld device, interacts with the design template and user marking by capturing an image via a camera associated with the computing device. The overlay kit application may then generate a custom digital overlay that incorporates the user marking received by the design template. Additionally, the overlay kit application may apply the custom digital overlay to one or more facial features detected in a user-selectable image.

### DESCRIPTION OF THE DRAWINGS

Illustrative embodiments of the disclosure are described in detail below with reference to the attached drawing figures, and wherein:

FIG. 1 is a top perspective view of an overlay portfolio kit, in accordance with an embodiment of the disclosure;

FIG. 2A is a top perspective view of a template overlay portfolio, in accordance with an embodiment of the disclosure;

FIG. 2B is a perspective view of a template overlay portfolio, in accordance with an embodiment of the disclosure;

FIG. 3 is a top perspective view of a template overlay portfolio and a computing device executing an application, in accordance with an embodiment of the disclosure;

FIG. 4A is a top view of a template overlay portfolio, in accordance with an embodiment of the disclosure;

FIG. 4B is a view of a computing device executing an application, in accordance with an embodiment of the disclosure;

FIG. 5 illustrates a series of top perspective views of a computing device executing an application, in accordance with an embodiment of the disclosure;

FIG. 6 depicts a flowchart illustrating a method for augmenting an digital image using an overlay kit application, in accordance with embodiments of the disclosure; and

FIG. 7 is an exemplary computing system for executing an application, in accordance with embodiments of the disclosure.

### DETAILED DESCRIPTION

The subject matter of embodiments of the disclosure is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In brief and at a high level, this disclosure describes, among other things, systems and methods for augmenting an image using a template overlay kit. Exemplary embodiments of the kit include a template portfolio comprising a template page having a first design template, wherein the first design template is configured to receive a user marking on the surface of a template page. In embodiments, an overlay kit application for execution by a computing device, such as a personal computer or handheld device, interacts with the design template and the received user markings using a camera associated with the computing device. The overlay kit application receives a captured image of the design template and the user's marking. Upon receiving the captured image of the design template and the user's marking, the overlay kit application may render a custom digital overlay that incorporates the user's marking received by the design template. The overlay kit application may then apply the custom digital overlay to one or more facial features detected in a user-selectable image.

In one embodiment, a template portfolio comprises a first template page having a first design template configured to receive a user marking. The template portfolio may further comprise an overlay kit application that, when executed by a computing device, receives a captured image comprising the first design template and the user marking. The overlay kit application generates a custom digital overlay in a display of the computing device. In embodiments, the custom digital overlay may be generated from a digital overlay template that incorporates the user marking received by the first design template. The overlay kit application may augment one or more facial features detected in a user-selectable image with the custom digital overlay incorporating the user marking.

In a further embodiment, a method is provided for augmenting an digital image using an overlay kit application that is executed on a computing device. The method comprises receiving, at a computing device, an indication to capture an image of a first design template. The first design template is associated with a first template page of a template portfolio and the first template page is configured to receive a user marking within the first design template. The method may further comprise identifying, via the computing device, the user marking received within the first design template. In addition, the method comprises generating, via the processor, a custom digital overlay by incorporating the user marking into a digital overlay template and augmenting a user-selectable image displayed on a screen of the computing device with the custom digital overlay incorporating the user marking.

In yet another embodiment, a template overlay kit comprises a template portfolio comprising one or more template pages having a first design template configured to receive a user marking. The template overlay kit further comprises an overlay kit application that, when executed by a computing device, receives an indication to capture an image of the first design template and identifies, in the captured image of the first design template, the user marking received by the first design template. The overlay kit application may generate a custom digital overlay by incorporating the user marking into a digital overlay template. Additionally, the overlay kit application augments, in a graphical user interface of the computing device, a user-selectable image with the custom digital overlay. The user may interact with the application, for example, through a graphical user interface.

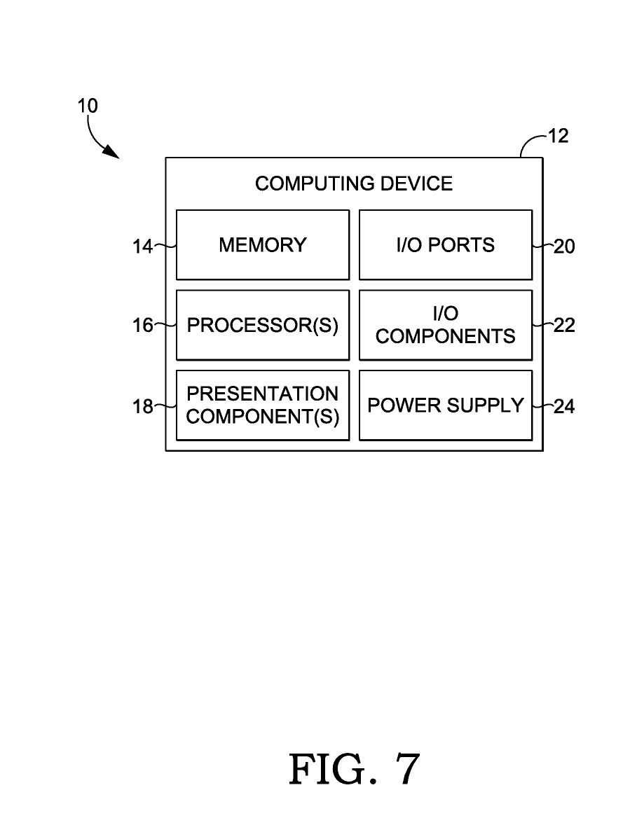

In brief and at a high level, this disclosure describes, among other things, referring initially to FIG. 7, an exemplary operating environment 10 in which embodiments of the present disclosure may be implemented as described below to provide a general context for various aspects of the present disclosure. Exemplary operating environment 10 includes a computing device 12, which is but one example of a computing environment for use with the present embodiments. The computing device 12 is not intended to suggest any limitation as to the scope of use or functionality of embodiments of the disclosure, and should not be interpreted as having any dependency or requirement relating to any one component nor any combination of components illustrated. As one skilled in the art would recognize, one or more of the components of operating environment 10 may be used to execute an application associated with embodiments of the disclosure.

Computing device 12 may include hand-held devices, consumer electronics, general-purpose computers, more specialty computing devices, touch-pad computing devices, touch-screen computing devices, and the like. Embodiments of the disclosure may be described in the general context of computer code or machine-useable instructions, including computer-useable or computer-executable instructions such as program modules, being executed by the computing device 12. The computing device 12 typically includes a variety of computer-readable media, which may be any available media that is accessible by the computing device 12, such as computer storage media that stores computer-executable instructions to be executed by the computing device 12. In one embodiment, computing device 12 is a touch-screen device having a camera, such as an iPod Touch®, iPad®, and/or an iPhone® device provided by Apple® Inc.

As shown in the exemplary embodiment included in FIG. 7, the computing device 12 includes the following components: a memory 14, one or more processors 16, one or more presentation components 18, one or more input/output (I/O) ports 20, one or more I/O components 22, and an illustrative power supply 24. As will be understood, the components of exemplary computing device 12 may be used in connection with one or more embodiments of the disclosure. In embodiments, computing device 12 may include fewer components than those depicted in FIG. 7, or other components in addition to those depicted in FIG. 7. In one embodiment, the computing device 12 may execute an overlay kit application to augment the user-selectable image with the custom digital overlay (e.g., the custom digital overlay 410) in a graphical user interface provided by the overlay kit application.

The memory 14 includes computer-storage media in the form of volatile and/or nonvolatile memory that may be removable, non-removable, or a combination thereof. The computing device 12 also includes one or more processors 16 that read data from various entities such as the memory 14 or the I/O components 22. The presentation component(s) 18 present data indications to a user or other device, such as a display device, speaker, printing component, vibrating component, and the like. The I/O ports 20 allow the computing device 12 to be logically coupled to other devices, while the I/O components 22 may include a microphone, joystick, game pad, satellite dish, scanner, printer, wireless device, and a controller, such as a stylus, a keyboard and a mouse, a natural user interface (NUI), and the like.

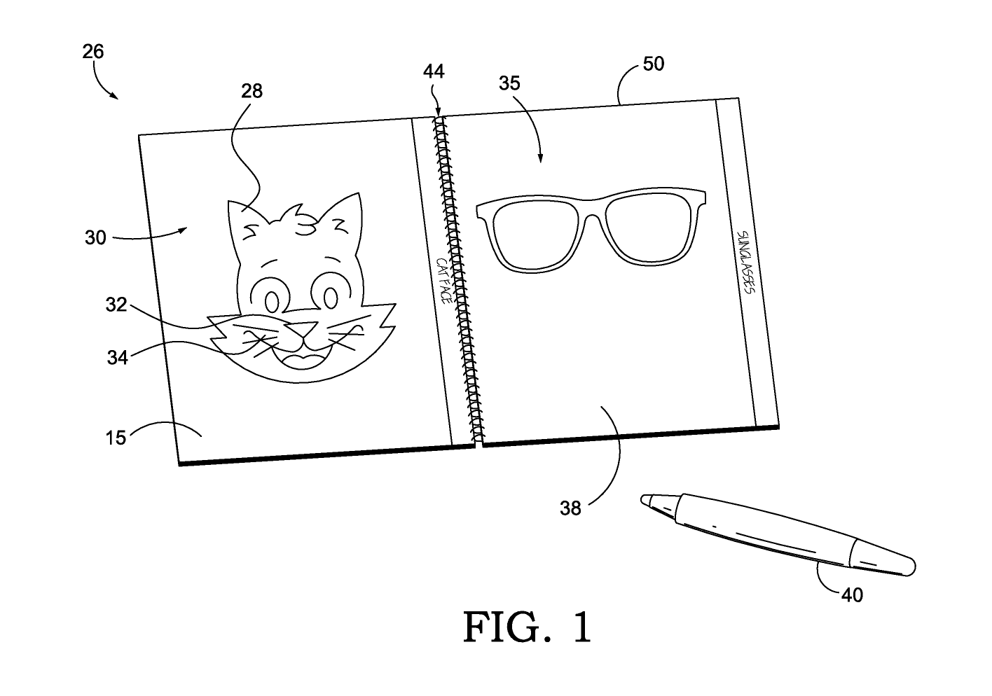

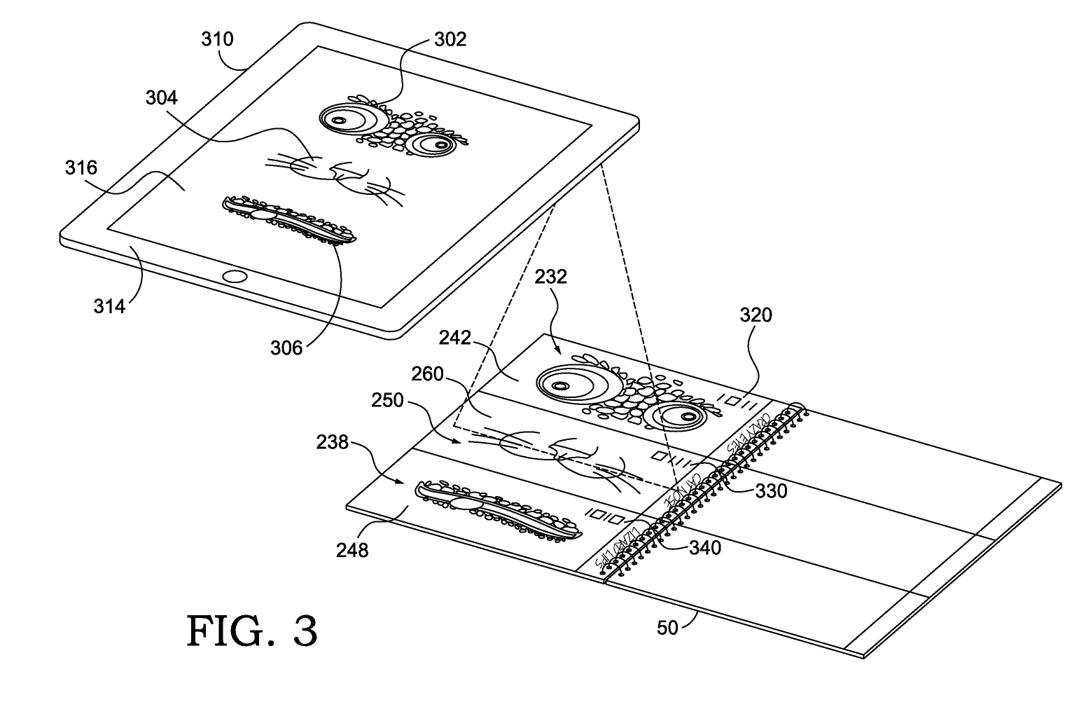

Turning next to FIG. 1, an embodiment of a template overlay portfolio kit 26 is depicted. As shown, the template overlay kit 26 may comprise a overlay template portfolio 50 having template pages 15 and 38 and a design marker 40. The configuration of the components of the template overlay portfolio kit 26 is not limited to that depicted by FIG. 1, and in various embodiments, the template overlay kit 26 may include any number of template pages and design markers. Embodiments of the template overlay kit 26 may also include an application for execution by a computing device that interacts with one or more of the components of the overlay template portfolio 50, such as the application being executed on the computing device as illustrated in FIG. 3.

In embodiments, the overlay template portfolio 50 includes any number of pre-printed template pages, such as template pages 15 and 38 in FIG. 1. Although depicted in FIG. 1 as having a spiral binding 44 coupling the template pages 15 and 38 to the overlay template portfolio 50, any means may be used to couple the template pages 15 and 38 together, such as any method to position and/or associate the template pages 15 and 38 with the overlay template portfolio 50, including clasps, tabs, adhesives, posts, rings, hooks, frames, and the like. Accordingly, the overlay template portfolio 50 may be a refillable portfolio for holding any number of template pages, such as refill template pages that may be provided to a user for placing inside the overlay template portfolio 50.

The surface of a template page and, thus, a design template, may be configured to receive user markings within the design template. For instance, a user may color in the pre-printed design templates 30 and 35 on template pages 15 and 38 using any number of the design markers 40. As such, the writing surface of template pages 15 and 38 may be any surface adapted to receive markings from the design marker 40. In one embodiment, the template pages 15 and 38 are paper surfaces for accepting markings from one or more of the design markers 40, which may include markers, pens, pencils, and/or any other design marker 40 configured to create a marking on a paper writing surface. In another embodiment, the template pages 15 and 38 are dry-erase surfaces for accepting dry-erasable markings from one or more of the design markers 40 configured to interact with a dry-erase surface, which includes dry-erase markers, dray-erase crayons, and/or any other design marker 40 configured to create a marking on a paper writing surface.

Accordingly, design marker 40 may be any type of marking device for marking on a surface, such as a washable marker, a permanent marker, a dry-erase marker, a crayon, a pencil, a colored pencil, a pen, and the like. Further, design marker 40 associated with template page 15 may be marking devices that are different from the design marker 40 associated with template page 38, such as design markers 40 including both a set of washable markers and a set of colored pencils.

As mentioned, the design template may be configured to receive the user marking on the surface of the template page associated with the design template. The design template may comprise a two-dimensional line drawing that provides an outline for coloring in by a user. Additionally, the design template may depict one or more overlay features. The term overlay feature generally refers to objects or features that may be used to augment a user-selectable image. In embodiments, the overlay feature augments facial features within the user-selectable image. As such, overlay features may comprise facial features, such as eyes, nose, mouth, and the like, or accessories, such as a hat, earrings, sunglasses, and the like. As shown in FIG. 1, in one embodiment, the sunglass design template 35 may depict a sunglass overlay feature, which may augment a user's eyes. As a further example, the cat design template 30 may comprise a cat face overlay feature, which may augment a user's head. Any and all aspects, and any variation thereof, are contemplated as being within aspects herein.

In one embodiment, the design template may comprise a plurality of overlay features. As shown in FIG. 1, a cat design template 30 may provide for a plurality of animal-like overlay features (e.g., whiskers overlay feature 34, cat-like ears overlay feature 28, and a cat-like nose overlay feature 32) on a single template page 15. In embodiments, the whiskers overlay feature 34 augments the user's cheeks, while the cat-like ears overlay feature 28 and the cat-like nose overlay feature 32 augment the user's eyes and the user's nose, respectively. This may be achieved, for example, by generating the custom digital overlay based on the whiskers overlay feature 34, the cat-like ears overlay feature 28, and the cat-like nose overlay feature 32 depicted by the design template 30 associated with template page 15.

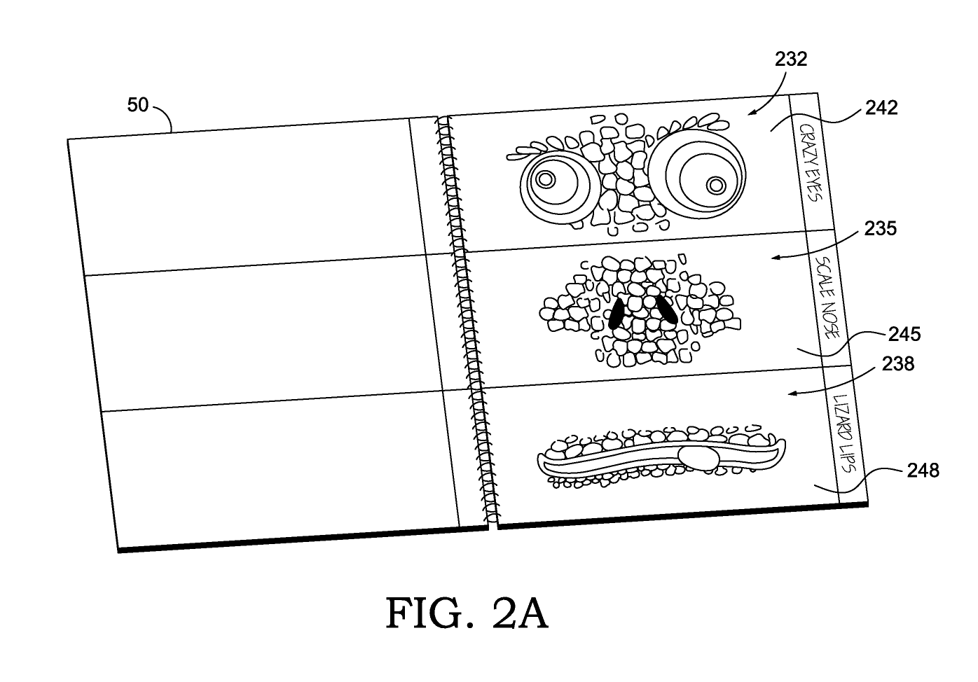

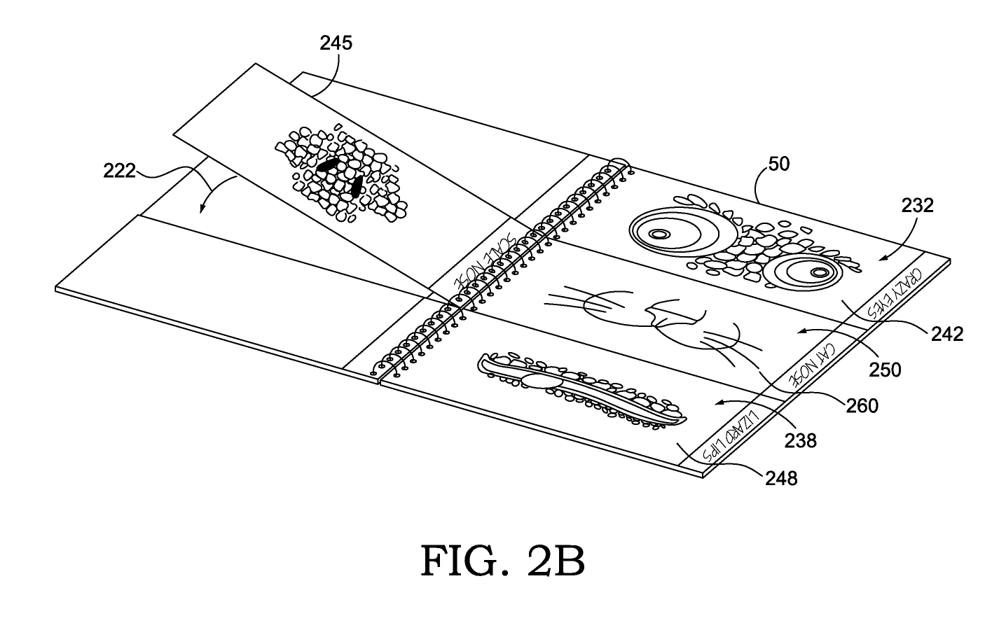

With reference to FIG. 2A, two or more design templates may be simultaneously presented in the overlay template portfolio 50 to facilitate unique combinations of overlay features. While FIG. 2A depicts the two or more design templates as presented in the overlay template portfolio 50, the two or more design templates may be independent of the overlay template portfolio 50. In one embodiment, design templates 232, 235, and 238 correspond to template pages 242, 245 and 248, respectively, thereby facilitating a unique combination of overlay features. As can be seen, a crazy eyes design template 232 may correspond to a first template page 242 and may depict a crazy eyes overlay feature. The crazy eyes design template 232 may be presented alongside a scale nose design template 235, which corresponds to a second template page 245 and depicts a scale nose overlay feature. Even more, both the crazy eyes design template 232 and scale nose design template 235 may be presented alongside a lizard lips design template 238, which corresponds to the third template page 248 and depicts a lizard lips overlay feature. Accordingly, the custom digital overlay can be generated based on the unique combination of overlay features presented by the two or more design templates. That is, the custom digital overlay may be generated based on the scale nose overlay feature, the scale nose overlay feature, and the lizard lips overlay feature presented by design templates 232, 235, 238 corresponding to template pages 242, 245, 248.

In embodiments, the overlay template portfolio 50 may comprise a series of template pages to further facilitate unique combinations of overlay features through the interchanging the template pages. As shown in FIG. 2B, in one embodiment, the overlay template portfolio 50 comprises a fourth template page 260 having a cat nose design template 250 and positioned behind the second template page 245. While a first combination of overlay features may be presented by design templates 232, 235, and 238 (as shown in FIG. 1A), a second combination of features may be presented by interchanging the scale nose design template 235 with the cat nose design template 250. As shown, interchanging the design templates may be achieved by the turning of the second page 245 (depicted by element 222) so as to reveal the concealed fourth template page 260. By interchanging the design templates, the second combination of design templates 232, 250, 238 may depict a second combination of overlay features. For instance, the second combination of overlay features may comprise the crazy eyes overlay feature depicted by the first design template 232, the cat nose overlay feature depicted by the fourth design template 250, and the lizard lips overlay feature depicted in the third design template 238. Accordingly, a first design template of the first combination of overlay features may be interchangeable with a second design template to present a second combination of overlay features.

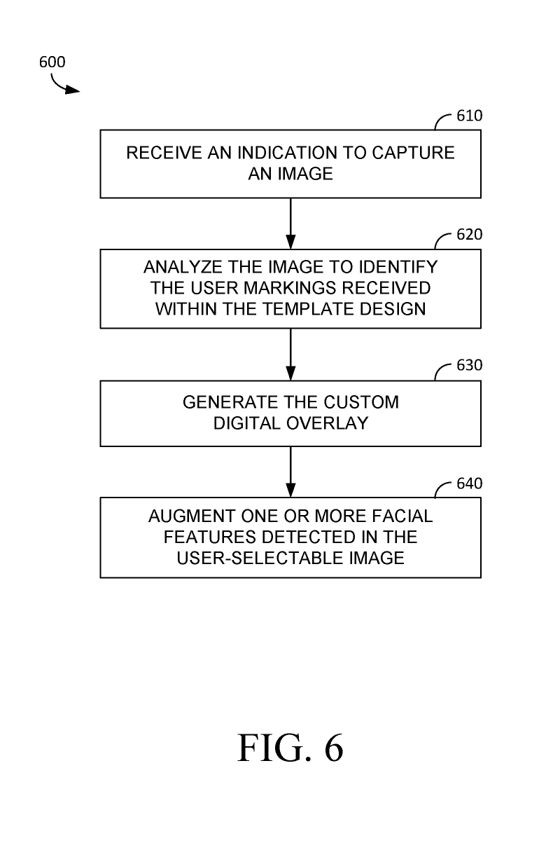

Referring now to FIG. 3, an embodiment of the overlay portfolio kit 26 may include the overlay kit application that is executable on a computing device 310. Computing device 310 may be any computing device adapted to execute an application associated with the overlay portfolio kit 26, such as computing device 10 of FIG. 7. Exemplary computing devices may include an iPod Touch®, iPad®, and/or an iPhone® device provided by Apple® Inc. In one embodiment, computing device 310 includes a housing 314 and a screen 316. In embodiments, the screen 316 of computing device 310 is a touch-screen display. In further embodiments, computing device 310 may be any computing device that includes at least one camera for capturing an image of the template outline on the template page of the overlay template portfolio 50. In addition, the overlay kit application may comprise various components or sub-components (like the components discussed in reference to FIG. 6) of computer executable code.

In embodiments, the overlay kit application may receive an image of the design template that was captured by a camera associated with the computing device 310. The computing device 310 may capture and store the image based on receiving a user indication to capture the image of the design template. The overlay kit application may then receive or load the captured image captured by the camera, for instance, via the processor of the computing device 310.

Further, the overlay kit application may identify the design template in the captured image. For instance, in one embodiment, the overlay kit application identifies the design template through a machine-readable label, such as a barcode or other identifiable features, located on the template page. When the computing device receives a captured image of the unique combination of design templates, it can identify one or more machine-readable labels associated with each design template within the captured image. As shown in FIG. 3, in one embodiment, the overlay kit application may load digital overlay templates 302, 304, and 306 corresponding to design templates 232, 235, and 248 of the overlay template portfolio 50 based on identifying machine-readable labels 320, 330, and 340. In a further embodiment, the overlay kit application can identify the design template based on analyzing the demarcations of the outline printed on the template page. This may be achieved, for example, by using image recognition and/or pattern matching software to determine that the demarcations match the demarcations of a template stored in a template database. In this way, any number of design templates may be identified within the captured image.

Upon identifying the design template in the captured image, the overlay kit application may load the digital overlay template associated with the design template. The digital overlay template may be a digitally rendered model based on the two dimensional outline of the design template. As such, the digital overlay template may have similar visual features as that of the design template. It should be appreciated that the digital overlay template may be a two-dimensional or a three-dimensional digital model.

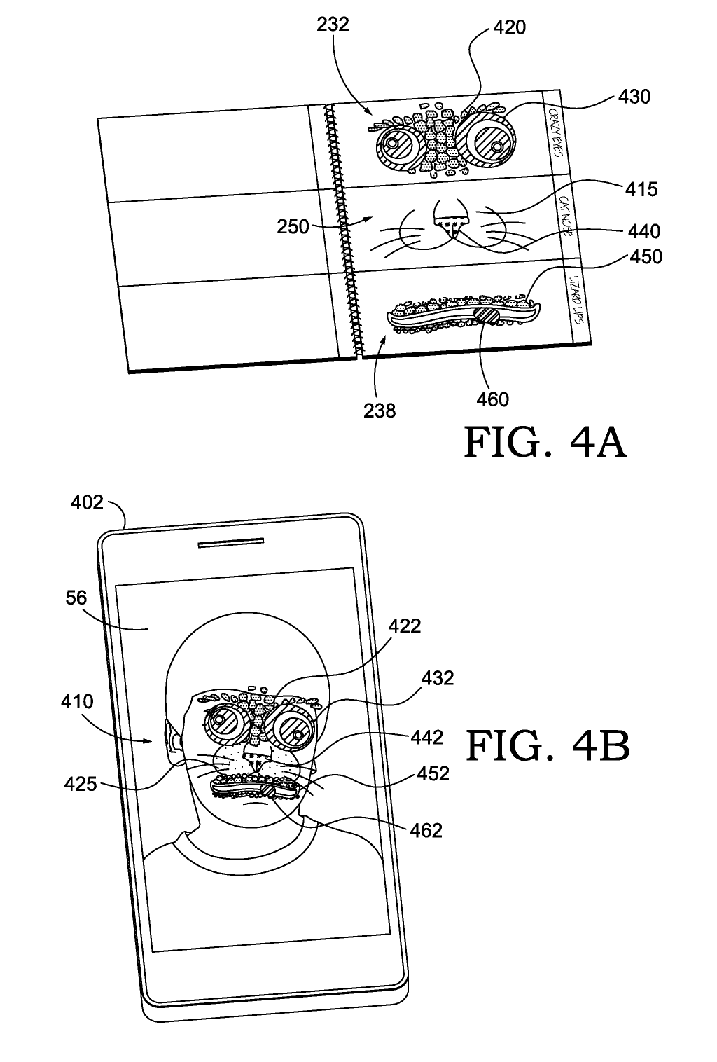

As shown in FIG. 3, digital overlay templates 302, 304, and 306 have similar visual features as design templates 232, 235, and 248. In embodiments, the overlay kit application may load a crazy eyes digital overlay template 302 based on detecting a crazy eyes design template 232. Further, the overlay kit application may load a cat nose digital overlay template 304 based on detecting the cat nose design template 250. Further still, the overlay kit application may load a lizard lips digital template 306 based on detecting the lizard lips design template 238. Accordingly, the overlay kit application may load one or more digital overlay templates based on the combination of design templates identified in the captured image. In embodiments, the custom digital overlay 410 (of FIG. 4B) may be generated from the crazy eyes digital overlay template 202, the cat nose digital overlay template 204, and the lizard lips digital overlay template 206. Any and all aspects, and any variation thereof, are contemplated as being within aspects herein.

Turning now to FIGS. 4A-B, embodiments of the overlay kit application may generate the custom digital overlay 410 based on the user markings received by the design template. As mentioned, the computing device 402 may receive the captured image of the one or more design templates. Further, the overlay kit application may identify one or more design templates within the captured image and load the corresponding digital design template(s). In addition to identifying the one or more design templates within the captured image, the overlay kit application may further identify any user markings received by the design template, such as those made with design marker 40. In embodiments, the overlay kit application may identify the user's markings by analyzing visual qualities (e.g., colors, shading, shapes, patterns, and the like) of the user marking. The overlay kit application can then create a digital reproduction of the user markings having the same visual qualities (e.g., colors, shading, shapes, patterns, and the like) as the actual user markings received by the design template.

As mentioned, the overlay kit application may incorporate the user's markings into the digital overlay template to produce a rendered digital overlay. In embodiments, the overlay kit application renders the digital reproduction of the user's markings with the digital design template to generate the custom digital overlay 410. As shown in FIGS. 4A-B, the custom digital overlay 410 may be generated from user markings 420, 430, 440, 450, and 460 by applying the digital reproduction of the user's markings 422, 432, 442, 452, and 462 to digital design templates 302, 304, and 306.

In some embodiments, the overlay kit application allows for one or more rendered digital overlay to be combined so as to generate a custom digital overlay. Generally, this allows a user to mix and match the rendered digital overlay to create a custom digital overlay. As such, the overlay kit application may cause for display one or more rendered digital overlay features. In some embodiments, the overlay kit application can receive input from a user indicating a unique combination of rendered digital overlay features (lizard lips, cat nose, crazy eyes, etc.). For example, the overlay kit application may render a scale nose digital overlay feature and cat nose digital overlay feature. The overlay kit application may then cause these rendered overlay features to be presented on a display and allow a user to select between them. The overlay kit application can receive an indication from the user through an input on the computing device (such as a touch on a touchscreen) and, based on the received indication, combine the selected overlay feature with other rendered digital overlay features. Accordingly, the overlay kit application allows a user to manipulate and generate custom digital overlays.

In another embodiment, the overlay kit application may enhance the custom digital overlay by supplementing the user's markings. For example, the overlay kit application may analyze the design template and identify portions that do not include user's markings. In other words, the overlay kit application identifies portions of the design template that were left uncolored or blank by the user (e.g., blank portion 415). The overlay kit application may then supplement the user's markings to create a consistent or cohesive custom digital overlay. As illustrated in FIG. 4B, the overlay kit application may identify the blank portion 415 and generate the custom digital overlay with supplemental markings 425.

With continued reference to FIGS. 4A-B, the overlay kit application may augment a user-selectable image with the custom digital overlay 410. In embodiments, the overlay kit application may augment the user's face that is identified in a user-selectable image. The user-selectable image may be any suitable image that is capable of being displayed on the screen 56, including a still image and/or a video. In one embodiment, the user may select an image stored in the memory of the computing device 402. In embodiments, the user may select a live video stream that can be captured with the camera associated with the computing device 402.

The overlay kit application may receive the user-selectable image and analyze the image to identify the user's facial features contained therein. For instance, the overlay kit application may identify the eyes, nose, lips, and the like, of a user's portrait in the user-selectable image. As known in the art, the user's facial features may be identified and tracked using facial feature detection and/or tracking algorithms, as discussed below with reference to FIG. 6. Once identified, the overlay kit application may augment the identified facial features of the user-selectable image by applying the custom digital overlay 410 over and/or proximate to the facial features. As shown in FIG. 4B, the custom digital overlay 410 may augment the eyes of the user with the crazy eyes overlay feature and the nose of the user with the cat nose overlay feature. Further, the lips of the user may be augmented with the lizard lips overlay feature. The overlay kit application may then track the user's detected facial features. As such, in embodiments, the overlay kit application can augment a video stream, where the user's facial features tend to move within the user-selectable image, by continuously tracking the facial features and applying the custom digital overlay 410 to the detected facial features.

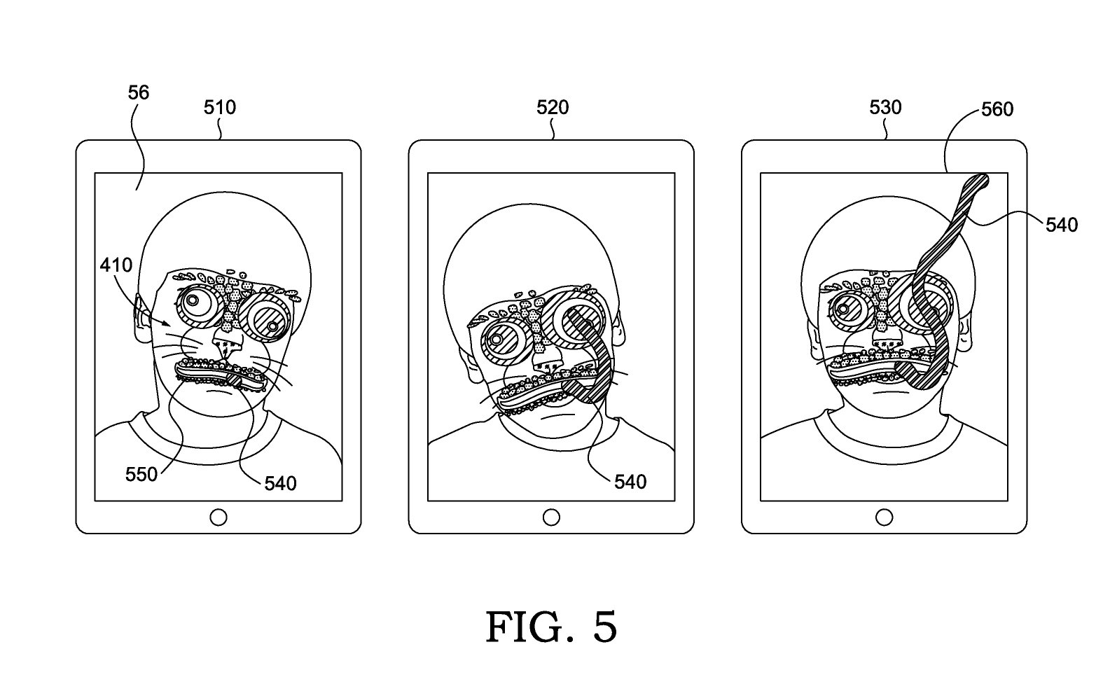

Turning now to FIG. 5, the custom digital overlay 410 may be animated. In an embodiment, the overlay kit application may apply a visual effect to each overlay feature. For instance, depending on the nature of the overlay feature being animated, the overlay kit application may apply a unique visual effect that is associated the with the overlay feature being animated. As discussed, in embodiments, overlay features may relate to facial features, such as the user's eyes, mouth, nose, and the like. Accordingly, if the overlay feature depicts a mouth or lips, the overlay kit application may apply a smiling visual effect. Additionally or alternatively, in embodiments where the overlay feature depicts eyes, the overlay kit application may apply a winking visual effect.

In some embodiments, the overlay feature may be animated. With continued reference to FIG. 5, elements 510, 520, and 530 illustrate the overlay kit application applying an exemplary animation to the lizard lips overlay feature. The animation is created by applying the visual effect of extending a lizard tongue 540 from within the lizard lips 550 (illustrated by element 510) to outside the mouth (illustrated by element 520). The lizard lips 550 may be animated further by extending the lizard tongue 540 to an edge 560 of the screen 56 (illustrated by element 530).

Turning now to FIG. 6, a flowchart is depicted illustrating a method 600 of generating the custom digital overlay is illustrated in accordance with embodiments herein. The method 600 may be executed on the computing device 10 of FIG. 7 and may offer an improved graphical user interface. At step 610, an indication may be received by the overlay kit application to capture an image. For example, the indication may be received through the I/O components 22 and/or through input from the touch-screen of the computing device screen 56. In embodiments, the indication may be received based on a visual prompt offered within the graphical user interface. The prompt may request the user position the computing device so as to capture the overlay design template associated with one or more template pages of the template portfolio (as shown in FIG. 3). The overlay kit application may then receive the indication to capture the image of the overlay design template. Upon receiving the indication to capture the image, the overlay kit application may instruct the computing device to capture the image, for example, by utilizing the camera associated with the computing device.

At step 620, the overlay kit application may analyze the captured image of the overlay design template. In addition to analyzing the captured image to identify the design template (as discussed above), the overlay kit application may identify the user marking received within the design template. This may be achieved, for instance, by an image recognition component within the overlay kit application. In one embodiment, the image recognition component can identify user markings (e.g., colors, shades, shapes, patterns) that were received by the design template on the template page.

At step 630, the overlay kit application may generate the custom digital overlay by incorporating the user marking into the digital overlay template. In embodiments, an overlay generator can determine a digital replica of the user marking and incorporate the digital replica into the digital design template. For example, the overlay generator may analyze the color profile of the user marking and create a digital replica that is consistent the user's marking color profile. The digital replica may then be applied to the digital design template. In this way, the overlay kit application may incorporate all of the user's markings (e.g., color, shading, shapes, and patterns) into the digital design template. Once the user's markings are incorporated into the digital design template, the overlay generator can generate a custom digital overlay. In embodiments, the overlay generator can then store the custom digital overlay in computer-storage media and render the custom digital overlay for display on the computing device screen 56.

At step 640, the overlay kit application may augment one or more facial features detected in the user-selectable image. In embodiments, the overlay kit application may receive the user-selectable image. The user-selectable image may be a photograph or a video stream that the user selects through interacting with the graphical user interface. The user-selectable image may be provided to the overlay kit application through components associated with the computing device. For instance, in one embodiment, the user-selectable image is a live video stream that is being captured through the camera associated with the computing device. The overlay kit application may then receive the live video stream from via the processor 16 of user computing device 10.

Further, the overlay kit application may analyze the user-selectable image to identify and track facial features. For instance, the overlay kit application may employ facial detection and tracking algorithms that are known in the art to detect facial features depicted in the user-selectable image. In one embodiment, the overlay kit application detects facial features by identifying landmark features using geometric-based facial recognition algorithms. In yet another embodiment, the overlay kit application detects facial features by identifying landmark features using photometric-based facial recognition algorithms. As such, the overlay kit application may identify the relative position, size, and/or shape of the identified facial features and augment the features by placing the overlay features of the custom digital overlay over and/or proximate to the identified facial feature. Any and all aspects, and any variation thereof, are contemplated as being within aspects herein.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for augmenting a digital image using a template overlay kit comprising:
a template portfolio comprising a first template page having a first design template configured to receive a user marking; and
an overlay kit application that, when executed by a computing device, receives a captured image comprising the first design template and the user marking, and generates a custom digital overlay in a display of the computing device,
wherein the custom digital overlay is generated from a digital overlay template that incorporates the user marking received by the first design template, and
wherein the custom digital overlay incorporating the user marking augments one or more facial features detected in the user-selectable image.

2. The system of claim 1, wherein the template portfolio further comprises a second design template configured to receive a second user marking, and wherein the custom digital overlay is further generated from a second digital overlay template that incorporates the second user marking.

3. The system of claim 2, wherein the second design template is associated with the first template page.

4. The system of claim 2, wherein the second design template is associated with a second template page.

5. The system of claim 2, wherein the first design template corresponds to a first overlay feature and the second design template corresponds to a second overlay feature.

6. The template overlay kit of claim 1, wherein overlay kit application animates the custom digital overlay.

7. The template overlay kit of claim 1, wherein the user-selectable image is a video stream.

8. A method for augmenting an digital image using an overlay kit application that is executed on a computing device, the method comprising:
receiving, at the computing device, an indication to capture an image of a first design template, wherein the first design template is associated with a first template page of a template portfolio, wherein the first template page is configured to receive a user marking within the first design template;
identifying, via a processor, the user marking received within the first design template;
generating, via the processor, a custom digital overlay by incorporating the user marking into a digital overlay template; and
augmenting a user-selectable image displayed on a screen of the computing device with the custom digital overlay incorporating the user marking.

9. The method of claim 8, wherein the template portfolio comprises a second design template.

10. The method of claim 9, wherein the custom digital overlay is further generated by incorporating a second user marking made within the second design template.

11. The method of claim 10, wherein the first design template corresponds to a first template page of the template portfolio and the second design template corresponds to a second template page of the template portfolio.

12. The method of claim 11, wherein the first design template is associated with a first overlay feature and the second design template is associated with a second overlay feature.

13. The method of claim 8, further comprising detecting one or more facial features in the user-selectable image.

14. The method of claim 13, wherein the one or more detected facial features is one of the following: an eye, a nose, an ear, and lips.

15. The method of claim 14, wherein the user-selectable image is augmented by applying the custom digital overlay proximate to the one or more detected facial features.

16. A system for augmenting a digital image using a template overlay kit comprising:
a template portfolio comprising one or more template pages having a first design template configured to receive a user marking; and
an overlay kit application that, when executed by a computing device:
receives an indication to capture an image of the first design template,
identifies, in a captured image of the design template, the user marking received by the first design template,
generates a custom digital overlay by incorporating the user marking into a digital overlay template, and
augments, in a graphical user interface of the computing device, a user-selectable image with the custom digital overlay incorporating the user marking.

17. The system of claim 16, wherein the overlay kit application detects one or more facial features in the user-selectable image.

18. The system of claim 17, wherein the user-selectable image is augmented by applying the custom digital overlay proximate to the one or more detected facial features.

19. The system of claim 16, wherein the template portfolio further comprises a second design template configured to receive a second user marking, and wherein the custom digital overlay is further generated by incorporating the second user marking into the digital overlay template.

20. The system of claim 18, wherein the first design template corresponds to a first template page of the template portfolio and the second design template corresponds to a second template page of the template portfolio.
